(19) United States
(12) Patent Application Publication
(10) Pub. No.: US 2017/0293595 A1
(43) Pub. Date: Oct. 12, 2017

(54) SYSTEM AND METHOD FOR LEARNING SEMANTIC ROLES OF INFORMATION ELEMENTS

(71) Applicant: Verint Systems Ltd., Herzliya Pituach (IL)

(72) Inventors: Itay Malleron, HERZLIYA PITUACH (IL); Itai Zilberstein, HERZLIYA PITUACH (IL)

(21) Appl. No.: 15/485,751

(22) Filed: Apr. 12, 2017

(30) Foreign Application Priority Data
Apr. 12, 2016 (IL) 245060

(51) Int. Cl. G06F 17/22; G06F 17/27; G06F 17/30

(52) U.S. Cl. CPC G06F 17/2282; G06F 17/30507; G06F 17/2785

(57) ABSTRACT

Rules are automatically learned via machine-learning techniques to deduce the semantic roles of extracted information elements, as well as, compute the respective levels of certainty that the semantic roles are indeed as deduced. Such a process is referred to herein as “tagging” the information elements. The tagged information elements are then associated, in a database, with their respective deduced semantic roles and levels of certainty. The machine-learning techniques provided herein include supervised, unsupervised, and semi-supervised techniques. Embodiments described herein may be applied to data leakage prevention, cyber security, quality-of-service analysis, lawful interception, or any other relevant application.

### FIELD OF THE DISCLOSURE

The present disclosure relates to the field of communication monitoring, and particularly to the extraction of information from the monitored communication.

### BACKGROUND OF THE DISCLOSURE

U.S. Pat. No. 7,650,317, whose disclosure is incorporated herein by reference, describes an active learning framework to extract information from particular fields from a variety of protocols. Extraction is performed in an unknown protocol, in which the user presents the system with a small number of labeled instances. The system then automatically generates an abundance of features and negative examples. A boosting approach is then used for feature selection and classifier combination. The system then displays its results for the user to correct and/or add new examples. The process can be iterated until the user is satisfied with the performance of the extraction capabilities provided by the classifiers generated by the system.

US Patent Application Publication 2012/0331556, whose disclosure is incorporated herein by reference, describes a method for generating a fingerprint based on properties extracted from data packets received over a network connection and requesting a reputation value based on the fingerprint. A policy action may be taken on the network connection if the reputation value received indicates the fingerprint is associated with malicious activity. The method may additionally include displaying information about protocols based on protocol fingerprints, and more particularly, based on fingerprints of unrecognized protocols. In yet other embodiments, the reputation value may also be based on network addresses associated with the network connection.

US Patent Application Publication 2015/0215429, whose disclosure is incorporated herein by reference, describes systems and methods for extracting identifiers from traffic of an unknown protocol. An example method can include receiving communication traffic transferred over a communication network in accordance with a communication protocol. A data item that matches a predefined pattern can be identified in the communication traffic, irrespective of the communication protocol. The identified data item can then be extracted from the communication traffic.

### SUMMARY OF THE DISCLOSURE

There is provided, in accordance with some embodiments described herein, a system that includes a network interface and one or more processors. The processors are configured to, using training data that include information elements, automatically learn a rule that relates to a semantic role of at least a subset of the information elements. The processors are further configured to, subsequently, extract, from communication exchanged over a computer network and received via the network interface, an information element whose semantic role is uncertain, and, using the rule, deduce the semantic role of the extracted information element.

In some embodiments, the processors are further configured to store the extracted information element, in a database, in a manner that indicates the deduced semantic role of the extracted information element.

In some embodiments, the processors are configured to compute a level of certainty that the semantic role of the extracted information element is as deduced, using the rule.

In some embodiments, the processors are further configured to store the extracted information element, in a database, in association with the level of certainty.

In some embodiments, the processors are configured to deduce the semantic role of the extracted information element by deducing that the extracted information element is a location of a particular device.

In some embodiments, the information elements included in the training data include ground truth information elements whose respective semantic roles are certain, and the processors are configured to use the training data by using the ground truth information elements.

In some embodiments, the subset of the information elements includes uncertain training information elements whose respective semantic roles are uncertain, and the processors are configured to automatically learn the rule by:

for each uncertain training information element of the uncertain training information elements:
selecting a corresponding one of the ground truth information elements that (i) is of the same type as the uncertain training information element, and (ii) was associated with a particular entity at a time that is within a particular threshold of a time at which the uncertain training information element was associated with the entity, and
ascertaining whether a value of the corresponding one of the ground truth information elements is sufficiently close to a value of the uncertain training information element; and

learning the rule, based on the ascertaining for all of the uncertain training information elements.

In some embodiments, the information elements included in the training data were extracted from communication exchanged in accordance with a particular application protocol, and the processors are configured to learn the rule by at least partly learning the particular application protocol.

In some embodiments, the processors are configured to automatically learn the rule by ascertaining that respective values of the information elements in the subset are sufficiently close to each other.

There is further provided, in accordance with some embodiments described herein, a method that includes, using training data that include information elements, automatically learning a rule that relates to a semantic role of at least a subset of the information elements. The method further includes, subsequently, extracting, from communication exchanged over a computer network, an information element whose semantic role is uncertain, and, using the rule, deducing the semantic role of the extracted information element.

There is further provided, in accordance with some embodiments described herein, a computer software product including a tangible non-transitory computer-readable medium in which program instructions are stored. The instructions, when read by one or more processors, cause the processors to, using training data that include information elements, automatically learn a rule that relates to a semantic role of at least a subset of the information elements. The instructions further cause the processors to, subsequently, extract, from communication exchanged over a computer network, an information element whose semantic role is uncertain, and, using the rule, deduce the semantic role of the extracted information element.

The present disclosure will be more fully understood from the following detailed description of embodiments thereof, taken together with the drawings, in which:

### BRIEF DESCRIPTION OF THE DRAWINGS

FIG. 1 is a schematic illustration of a system for deducing the respective semantic roles of information elements, in accordance with some embodiments described herein;

FIG. 2 shows a flow diagram for the operation of a supervised learner, in accordance with some embodiments described herein;

FIG. 3 shows a flow diagram for the operation of an unsupervised learner, in accordance with some embodiments described herein; and

FIG. 4 shows a flow diagram for the operation of an information-element tagger, in accordance with some embodiments described herein.

### DETAILED DESCRIPTION OF EMBODIMENTS

### Overview

In embodiments described herein, information elements are extracted, by a monitoring system, from communication exchanged over a computer network. Examples of such information elements include various properties of people, groups of people (e.g., a household, neighborhood, or organization, such as a company), or objects (e.g., a mobile device or motor vehicle), such as names, addresses, credit card numbers, phone numbers, e-mail addresses, Internet usernames (e.g., for logging in to applications such as Facebook), bank account numbers, dates of birth, car license-plate numbers, International Mobile Subscriber Identities (IMSIs), International Mobile station Equipment Identities (IMEIs), Internet Protocol (IP) addresses, media access control (MAC) addresses, and locations. Location information elements may include specific coordinates (e.g., expressed as a latitude and longitude), or more general locations (e.g., the name of a street, city, or country).

Some of the extracted information elements are communicated in accordance with application protocols that are known to the monitoring system, such that it is relatively straightforward to determine the respective semantic roles of the information elements. (In other words, it is relatively straightforward to “decode” the communication, and thus determine the semantic roles of the information elements.) Other information elements, however, are communicated in accordance with application protocols that are unknown to the monitoring system, such that the respective semantic roles of such information elements are unclear.

For example, if an e-mail was communicated in accordance with a known application protocol, it is relatively straightforward to determine whether a particular e-mail address extracted from the e-mail is the “from” or “to” address. (For example, it may be known that the application that sent the email always places the string “From:” before the “from” address, and the string “To:” before the “to” address in the communication.) On the other hand, if the e-mail was communicated according to an unknown application protocol, the meaning of the extracted e-mail address will be uncertain.

Another example involves an extracted location, expressed, for example, by a pair of coordinates. If the location was communicated in accordance with a known application protocol, the meaning of the location will be clear. On the other hand, if the location was communicated in accordance with an unknown application protocol, the meaning of the location will be unclear. For example, without knowing the protocol of the application that was used to communicate the location, it is unclear whether the location is (i) the current location of the device running the application (such as in the case of a weather application that is fetching a weather report for the device's current location), (ii) an intended destination (communicated, for example, by a travel application), (iii) the location of another device, or (iv) some other location.

In embodiments described herein, rules are automatically learned via machine-learning techniques. The learned rules are then used to deduce the semantic roles of extracted information elements, as well as, typically, compute the respective levels of certainty that the semantic roles are indeed as deduced. Such a process is referred to herein as “tagging” the information elements. (The term “tagging” may also refer to marking an information element as uncertain, if no suitable rule exists for deducing the sematic role of the information element.)

The tagged information elements are then associated, in a database, with their respective deduced semantic roles and levels of certainty. For example, deducing the semantic role of the extracted information element “bob@bobsworld.com” may comprise deducing that “bob@bobsworld.com” is a property of a particular person “Bob,” in that “bob@bobsworld.com” is Bob's email address. “bob@bobsworld.com” may then be stored in a database as Bob's email address, with a level of certainty of, for example, 80%, indicating that the system is 80% certain that “bob@bobsworld.com” is Bob's email address.

As further described below, the machine-learning techniques provided herein include supervised, unsupervised, and semi-supervised techniques.

Embodiments described herein may be applied to data leakage prevention, cyber security, quality-of-service analysis, lawful interception, or any other relevant application.

### System Description

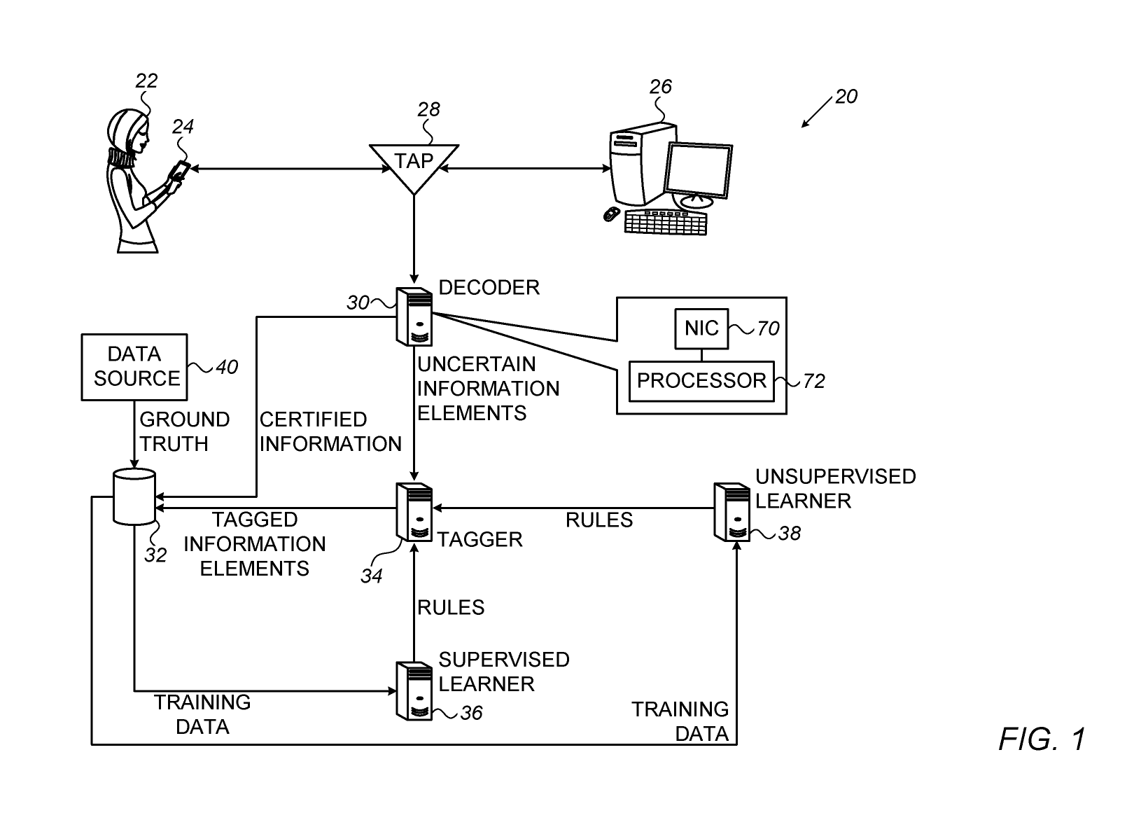

Reference is initially made to FIG. 1, which is a schematic illustration of a system 20 for deducing the respective semantic roles of information elements, in accordance with some embodiments described herein. System 20 comprises various functional components, including a decoder 30, a tagger 34, a supervised learner 36, and an unsupervised learner 38, the function of each of which is described below. Each of these components may be implemented in hardware, software, or a combination of hardware and software elements. For example, as shown in FIG. 1, each of decoder 30, tagger 34, supervised learner 36, and unsupervised learner 38 may be implemented on a separate respective server, each server comprising a processor 72 (which is explicitly shown only for decoder 30), configured to execute program code such as to perform the relevant tasks described herein.

Notwithstanding the particular example configuration of system 20 shown in FIG. 1, it is noted that many other configurations are included within the scope of the present disclosure. For example, any one of the components of system 20 may be embodied as a cooperatively networked or clustered set of processors. Moreover, two or more components of system 20 may be embodied by a single shared processor, or a single shared cooperatively networked or clustered set of processors. For example, a single processor, or a single shared cooperatively networked or clustered set of processors, may perform the tasks of both supervised learner 36 and unsupervised learner 38.

Due to the many possible configurations of system 20, the description below refers to particular tasks as being performed by the respective functional components that perform the tasks, without necessarily specifying which processor, or processors, are involved in performing the tasks.

Each processor in system 20 is typically a programmed digital computing device comprising a central processing unit (CPU), random access memory (RAM), non-volatile secondary storage, such as a hard drive or CD ROM drive, network interfaces, and/or peripheral devices. Program code, including software programs, and/or data are loaded into the RAM for execution and processing by the CPU and results are generated for display, output, transmittal, or storage, as is known in the art. The program code and/or data may be downloaded to the computer in electronic form, over a network, for example, or it may, alternatively or additionally, be provided and/or stored on non-transitory tangible media, such as magnetic, optical, or electronic memory. Such program code and/or data, when provided to the processor, produce a machine or special-purpose computer, configured to perform the tasks described herein.

FIG. 1 depicts a person 22 using a device 24 (which may also be referred to as a “client”) to exchange communication with another device, such as a server 26, e.g., over the Internet. System 20 comprises a network tap 28, which copies communication packets that are exchanged between device 24 and server 26, and passes the copies to decoder 30. Via a network interface, such as a network interface card (NIC) 70, the decoder receives the packets, and processes the packets as described below.

Decoder 30 decodes any packets that use known application protocols, thus extracting information elements whose semantic roles are known. These information elements, which may be referred to as “certified information,” are passed to a database 32. As further described below, these information elements may be used as ground truth (e.g., in combination with other ground truth received from other sources), to aid the supervised learning of rules.

It is noted that in the context of the present specification and claims, an application protocol need not necessarily be fully known in order to be considered “known.” For example, the decoder may know (e.g., based on a rule that is learned by the supervised learner) that the string “usermail” that appears in communication from the application “MailSender” is followed, with a high degree of certainty, by the sender's email address. Hence, even if the decoder does not know the semantic roles of other information elements sent by the application “MailSender,” the application “MailSender” may be considered to use a known application protocol, in that the decoder may extract certified information by decoding communication from “MailSender.”

Decoder 30 further extracts other information elements using regular expression matching, or using any other suitable technique, such as those described in US Patent Application Publication 2015/0215429, whose disclosure is incorporated herein by reference. Such extraction techniques typically provide information elements whose respective types are known, but whose respective semantic roles are a priori uncertain. (For example, regular expression matching may identify an email address, but not the semantic meaning of the email address.) These information elements are passed to tagger 34, which uses machine-learned rules to deduce the semantic roles of the information elements, with respective levels of certainty. (As noted above, such a process may be referred to as “tagging” the information elements.) Tagger 34 then associates each of the information elements, in database 32, with the element's deduced semantic role and the associated level of certainty.

For example, decoder 30 may extract a set of coordinates whose semantic role is uncertain, and pass this set of coordinates to tagger 34. Using one or more learned rules, tagger 34 may assign to the set of coordinates a level of certainty of 80% that the set of coordinates is the current latitude and longitude of device 24 (as opposed to, for example, the latitude and longitude of a planned destination). The tagger may then store the set of coordinates as the current location of device 24, with the level of certainty of 80%, in the database.

Typically, even if the semantic role of a particular information element cannot be deduced with a reasonable level of certainty (such as if no suitable rules are available to perform the deduction, or if the level of certainty associated with the deduction is less than a particular threshold), the tagger nonetheless stores the information element in the database as an “uncertain” information element. Such uncertain information elements may be used for learning rules, as described below.

Typically, upon extracting an information element, the decoder identifies the device and application with which the information element was exchanged, as well as the time at which the information element was associated with the relevant entity (e.g., person or device) to which the information element applies (i.e., the “time of the information element”). As further described below, this information (i) facilitates the tagging of the information element, and/or (ii) facilitates the learning process. Typically, the information element is stored in the database in association with the device, the application, and the time identified by the decoder.

To identify the device with which the information element was exchanged, the decoder may identify, in the packet that contains the information element, one or more identifiers that are associated with the device. Examples of such identifiers include subscriber identifiers, such as an IMSI or a Temporary Mobile Subscriber Identity (TMSI), and allocated IP addresses. In some cases, Remote Authentication Dial-In User Service (RADIUS) messages are monitored, in order to track any changes in allocated IP addresses, and thus continue to identify the device despite such changes. Alternatively or additionally, for example, messages transmitted under the General Packet Radio Service (GPRS) Tunneling Protocol (GTP) may be monitored.

To identify the application with which the information element was exchanged, the decoder may identify an explicit application identifier in the packet that contains the information element (or in an associated packet). Alternatively, the decoder may identify the application indirectly, based on properties of the packet, patterns of packet transmission, and/or other features.

To identify the time of the information element, the decoder may extract a time of packet generation or packet transmission from the packet that contains the information element, e.g., by using regular expressions to look for known time formats in the packet. Alternatively, assuming that packets are received in real-time (or near real-time), the time of the information element may be the system time of tap 28 or decoder 30 at receipt of the packet.

System 20 further comprises learning components, which are configured to process large amounts of data, and use sophisticated machine-learning techniques, such as to automatically learn the rules that are used to tag the information elements. As the available data continue to accumulate, these learning components continue to update the tagging rules, in order to further improve the accuracy of the tagging.

Typically, system 20 comprises both a supervised learner and an unsupervised learner 38. (Alternatively or additionally, system 20 may comprise a semi-supervised learner, which uses elements of both supervised and unsupervised learning.) As further described below, each of the two learners uses training data to automatically learn rules that relate to information elements in the training data. The training data include uncertain information elements, i.e., information elements whose semantic roles are uncertain, and, in the case of supervised learner 36, further include ground truth information elements whose semantic roles are certain. Such ground truth may include certified information, which, as described above, was decoded by decoder 30; alternatively or additionally, such ground truth may be obtained from a data source 40. Typically, the training data are retrieved from database 32 by the learners.

### Supervised Learning

The supervised learning performed by supervised learner 36 will now be described, in the context of an example scenario, in which the supervised learner learns a rule relating to location information elements exchanged with a hypothetical application “Take Me Somewhere.”

The supervised learner first retrieves, from database 32, a plurality of uncertain location information elements extracted from communication exchanged with the application “Take Me Somewhere,” which was run on one or more clients. For each of these uncertain information elements, the supervised learner retrieves, from database 32, a corresponding ground truth location information element. As further explained below, a ground truth information element corresponds to an uncertain information element if (i) it is of the same type as the uncertain information element, and (ii) it was associated with the same entity (e.g., person or device) at around the same time as was the uncertain information element.

For example, the supervised learner may retrieve an uncertain location information element (31.8, 35.2) that was sent by the application “Take Me Somewhere” from a particular device “Bob's iPhone,” at approximately 9:00 on January 1. (In this example, the device is identified by the appellation “Bob's iPhone” for ease of description, despite the fact that, in practice, it probably will not be known that the device is an iPhone™ belonging to Bob; rather, as noted above, it is probable that only the IMSI, or some other basic identifier of the device, will be known.) The supervised learner may then retrieve a ground truth location information element (31.75, 35.25) that was also associated with Bob's iPhone, at 8:55 on January 1. This latter information element is “ground truth,” in that its semantic role is known; it certainly indicates that Bob's iPhone was located at (31.75, 35.25) at 8:55 on January 1. Moreover, the ground truth was associated with Bob's iPhone at around the same time as was the uncertain information element, in that 8:55 is within a particular threshold (e.g., 10 minutes) of 9:00.

As described above, such ground truth may have been obtained by decoding communication exchanged in accordance with a known application protocol. Alternatively, such ground truth may have been obtained from data source 40. For example, data source 40 may comprise a cellular communication network; by monitoring cellular-communication signals exchanged with Bob's iPhone over the cellular communication network, the location of Bob's iPhone at 8:55 may be obtained.

Upon selecting a suitable ground truth information element, the supervised learner next checks whether the value of the ground truth information element is sufficiently close to that of the uncertain information element. Typically, the supervised learner first converts the uncertain information element to a suitable canonical form that is specific to the type of information element. For example, the supervised learner may convert an uncertain location element to the WGS84 Decimal Degrees format. Likewise, for phone numbers, the E.164 format may be used. Similarly, email addresses may be converted to lower case, with redundant stops removed. If necessary, the ground truth is also converted to the same canonical form. Then, as further explained below, the supervised learner checks whether the two values are sufficiently close to one another.

In general, to determine closeness in value, the supervised learner may use any suitable closeness function. For example, for numerical values, such as locations, the closeness function may compare the difference between the values to a suitable threshold. Thus, in the example above, it may be determined that the value (31.75, 35.25) of the ground truth is sufficiently close to the value (31.8, 35.2) of the uncertain information element, in that the two sets of coordinates are within a particular threshold of one another. Hence, since the ground truth is sufficiently close to the uncertain information element in both time and value, the ground truth helps clarify the semantic role of the uncertain information element. In particular, the ground truth indicates that since Bob's iPhone was near (31.8, 35.2) only 5 minutes before 9:00, (31.8, 35.2) is likely the location of Bob's iPhone at 9:00, rather than some other location. Such a correspondence between the uncertain information element and the ground truth is referred to below as a “positive correspondence.”

Conversely, if the ground truth were sufficiently close in time, but not in value, to the uncertain information element, the ground truth would indicate that (31.8, 35.2) is likely not the location of Bob's iPhone at 9:00. Such a correspondence is referred to below as a “negative correspondence.”

(Ground truth elements that are not sufficiently close in time to an uncertain information element are irrelevant with respect to the uncertain information element, i.e., they provide neither positive correspondence nor negative correspondence, and hence, are ignored vis-à-vis the uncertain information element. As described immediately below, the definition of “sufficiently close in time” varies, depending on the type of information element.)

The criteria that are used for pairing uncertain information elements with ground truth information elements vary, depending on the type of uncertain information element. For example, with respect to closeness in time, a threshold of only 10 minutes might be appropriate for location elements, but a much larger threshold might be appropriate for other types of information elements. Thus, for example, a ground truth Internet username associated with a particular person might correspond to an uncertain Internet username exchanged with the same person, as long as the ground truth Internet username was associated with the person within one year of receipt of the uncertain Internet username. Since a person's Internet usernames typically change less frequently than does the person's location, the larger time threshold is appropriate. For a proper-name information element (e.g., “Bob Smith”), an even greater threshold may apply, such that two proper-name information elements may be sufficiently close in time to one another, even if separated by a time period of many years (e.g., the “threshold” in such cases may be infinite).

Conversely, with respect to closeness in value, the closeness function for Internet usernames may be “tighter” than the closeness function for locations. For example, the closeness function for Internet usernames may determine that two values are sufficiently close only if they are exactly the same, such that a ground truth Internet username positively corresponds to an uncertain Internet username only if the respective canonical forms of the two usernames are exactly the same.

(As noted above, the canonical form compensates for any inconsistencies in the way an information element might be represented. For example, since email addresses belonging to the “hotmail.com” domain are case-insensitive, such email addresses are first converted to a canonical form—e.g., all lower-case letters—prior to being compared with each other. Thus, for example, the ground-truth information element “BOB@hotmail.com” may be found to positively correspond to the uncertain information element “Bob@hotmail.com.” As another example, for “gmail.com” email addresses, any redundant stops are removed when converting to canonical form, such that, for example, “b.o.b@gmail.com” may be found to positively correspond to “bob@gmail.com.”)

In general, the closeness function takes into account any differences in precision between the different sources of information. For example, the threshold for location closeness may account for the fact that ground-truth location information obtained from the monitoring of cellular communication is typically less precise—sometimes on the order of hundreds of meters—than uncertain location information having Global Positioning System (GPS) precision.

In some embodiments, a weighted proximity function is used to pair uncertain information elements with ground truth information elements. Thus, for example, a ground truth element that is very close to an uncertain information element in value may be paired with the uncertain information element, even if the two elements are less close to one another in time than would “otherwise” be acceptable.

For example, for a particular uncertain location information element (26.77832, 48.11627) sent by the application “Take Me Somewhere” from a particular device “Alice's iPhone” at 9:00 on January 1, the supervised learner may retrieve a ground truth location information element (26.77833, 48.11628) that was also associated with Alice's iPhone, at 7:00 on January 1. Although the times are a full two hours apart, the values are very close, and therefore, the ground truth element may be determined to positively correspond to the uncertain element.

In some embodiments, the supervised learner defines a curve passing through a two-dimensional plane, where one dimension is the time difference between the elements, and the other dimension is the value difference between the elements. Any given instance of potential correspondence may then be identified as a point on the plane. If this point is on one side of the curve, the correspondence is accepted; otherwise, the correspondence is rejected.

Following the retrieval of the training data, the supervised learner learns a rule that relates to the information elements in the training data, based on instances of both positive correspondence and negative correspondence in the training data. To learn the rule, the supervised learner first extracts potentially relevant features associated with the uncertain location elements, and then learns which features, or combinations of features, indicate the respective semantic roles of the location elements. To perform such learning, the supervised learner may make use of any relevant supervised-learning techniques, including, for example, decision trees, support vector machines, or k-nearest neighbors.

Examples of potentially relevant features include regular expressions that surround the uncertain information element, the communication protocol under which the uncertain information element was communicated (e.g., the Transmission Control Protocol or the User Datagram Protocol), the server host address or ports, the direction (to or from the client) in which the uncertain information element was communicated, the size of the packet from which the uncertain information element was extracted and/or sizes of other packets in the message, the number of bytes preceding the uncertain information element (in the packet, and/or in the message), ratios between sizes of packets or messages, types of encoding (e.g., HTTP), types of methods (e.g., POST), the type of user agent with which the information element was exchanged (e.g., Chrome™ for Android™), whether compression was used, the existence of other, certain information elements, and the time of day at which the uncertain information element was exchanged.

Effectively, in performing the supervised learning, the supervised learner partly learns the application protocol used by the application of interest. For example, the supervised learner may learn that, in 90% of cases in the training data, the application “Take Me Somewhere” sends the current location of the device in the third outgoing packet, after the first N bytes of the packet. As another example, the supervised learner may learn that, in messages sent by “Take Me Somewhere,” the expression “currentLoc” precedes the current location of the device. The application “Take Me Somewhere” thus becomes a “known” application protocol as defined above, in that at least some subsequent communication exchanged with the application may be decoded, as described immediately below.

Further to learning the rule, the supervised learner passes the rule to the tagger. As described above, the tagger may then use the learned rule, in “real-time,” to associate another information element, extracted from the same application, with a semantic role, with a particular level of certainty.

For example, in real-time, tagger 34 may receive a location element that was sent from device 24, by the application “Take Me Somewhere,” in the third outgoing packet, after the first N bytes of the packet. In response to the example rule described above, the tagger may assign, to the location element, a level of certainty of 90% (based on the 90% “hit rate” in the training data) that the location element is the current location of the device. The tagger may then save the location element in database 32, in association with the deduced semantic role and the level of certainty.

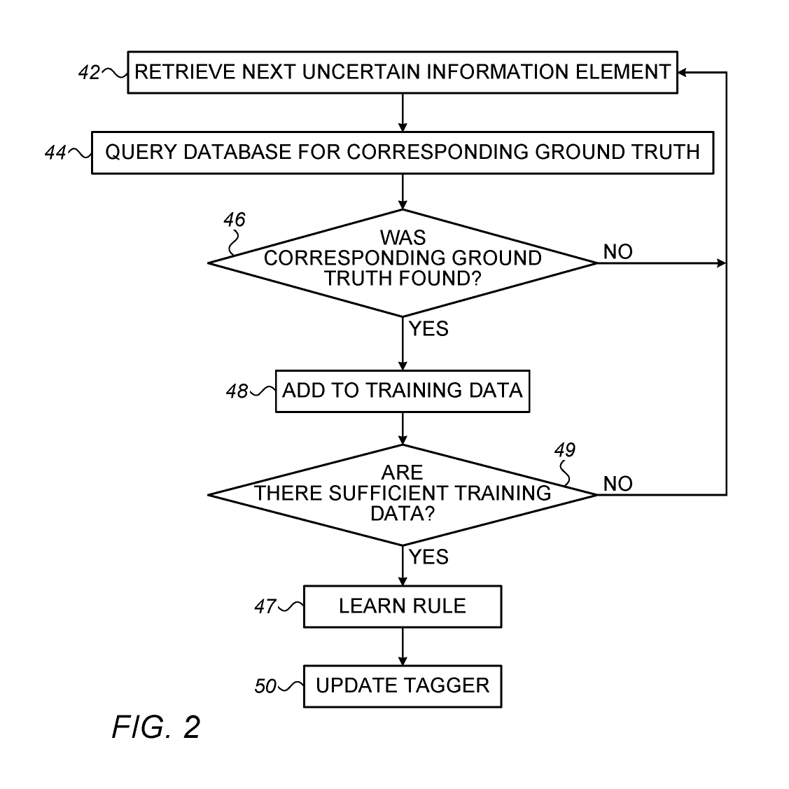

Reference is now made to FIG. 2, which shows a flow diagram for the operation of supervised learner 36, in accordance with some embodiments described herein.

In a first retrieving step 42, the supervised learner retrieves, from the database, an uncertain information element that was exchanged with a particular application. In a querying step 44, the supervised learner then queries the database for a corresponding ground truth information element. (As described above, the ground truth information element corresponds to the uncertain information element if the two information elements are of the same type, and were associated with the same client within a particular time threshold.) At a first evaluation step 46, the supervised learner then evaluates whether corresponding ground truth was found. If yes, the supervised learner adds the pair of information elements to the training data. Otherwise, the next uncertain information element is retrieved.

At a second evaluation step 49, the supervised learner evaluates whether there are sufficient training data. If there are not, the supervised learner returns to first retrieving step 42, and retrieves another uncertain information element that was exchanged with the same application as was the first. (As noted above, the uncertain information elements used for supervised learning share a common application.) Once there are sufficient training data, the supervised learner, at a learning step 47, learns a rule from the training data, and, at an updating step 50, updates the tagger with the learned rule.

In performing second evaluation step 49, the supervised learner may learn a rule from a first subset of the training data, apply the rule to a second subset of the training data, and evaluate the sufficiency of the training data based on how well the rule performs on the second subset.

### Unsupervised Learning

The unsupervised learning performed by unsupervised learner 38 will now be described, in the context of an example scenario, in which the unsupervised learner learns a rule relating to information elements exchanged with a hypothetical client “Bob's iPhone.”

The unsupervised learner first retrieves, from database 32, a plurality of uncertain information elements of the same type, which were extracted from communication exchanged with Bob's iPhone. Typically, the uncertain information elements were received within a particular time threshold of each other. Analogously to that which was described above, the time threshold is typically dependent on the type of information element, such that, for example, location elements will have a tighter time threshold than Internet username elements.

It is noted that the “common denominator” between the elements of the training data is different in the unsupervised case from the supervised case. For supervised learning, the uncertain information elements in the training data share a common application protocol, but not necessarily a common client; on the other hand, for unsupervised learning, the uncertain information elements share a common client, but not necessarily a common application protocol. Also, for unsupervised learning, as opposed to supervised learning, the training data do not include ground truth.

Following the retrieval of the training data, the unsupervised learner learns a rule that relates to the information elements in the training data. Typically, the unsupervised learner learns the rule by ascertaining that a subset of the information elements in the training data are sufficiently close in value to each other. As explained above, the closeness function used to ascertain closeness depends on the type of information element.

For example, the training data may include 1000 email-address information elements, of which 800 have the canonical form “bob@bobsworld.com,” and the remainder include various other email addresses. Given that “bob@bobsworld.com” appears much more frequently than any other email address, it is likely that “bob@bobsworld.com” is the email address of the user of Bob's iPhone. The unsupervised learner thus learns a rule: for a particular period of time (e.g., for up to one year from the most recent use of “bob@bobsworld.com”), the information element “bob@bobsworld.com” is to be associated with the user of Bob's iPhone. Subsequently, tagger 34 uses the rule to deduce the semantic role of any received information elements “bob@bobsworld.com.”

In another example case, the training data may contain 100 location information elements, of which 75 are within a particular distance threshold of each other. Given the data, it is likely that Bob's iPhone was at the respective locations indicated by the 75 location elements, at the respective times that the location elements were time-stamped or received. The unsupervised learner thus learns a rule: for a particular period of time (e.g., for up to one hour from the time of receipt of the most recently received location element), any location element that is exchanged with Bob's iPhone, and is within a particular threshold of the next-most recently received location element, is the current location of the device. Subsequently, tagger 34 uses the rule to tag any appropriate location elements exchanged with Bob's iPhone.

In learning a rule, the unsupervised may use any suitable clustering algorithm, including, for example, the k-means algorithm.

For tagging based on a rule that was learned by unsupervised learning, the level of certainty may be computed using any suitable function that takes, as arguments, (i) the total number of information elements in the training data (1000 or 100 in the examples above), (ii) the total number of “clustered” information elements (800 or 75 in the examples above), and/or (iii) any other suitable arguments (e.g., the proximity between the tagged information element and the next-most recently received information element).

It is noted that the tagging of information elements based on rules learned by the unsupervised learner is an end in itself, and is also a means for providing more ground truth for the supervised learner. For example, the tagging of “bob@bobsworld.com” is an end in itself, in that it may be helpful to know that “bob@bobsworld.com” is the email address of the user of Bob's iPhone. Moreover, if the tagged level of certainty is high enough to render this instance of “bob@bobsworld.com” certified information (e.g., the level of certainty exceeds some threshold, e.g., 90%), the supervised learner can use this instance of “bob@bobsworld.com” as ground truth, to aid the performance of supervised learning.

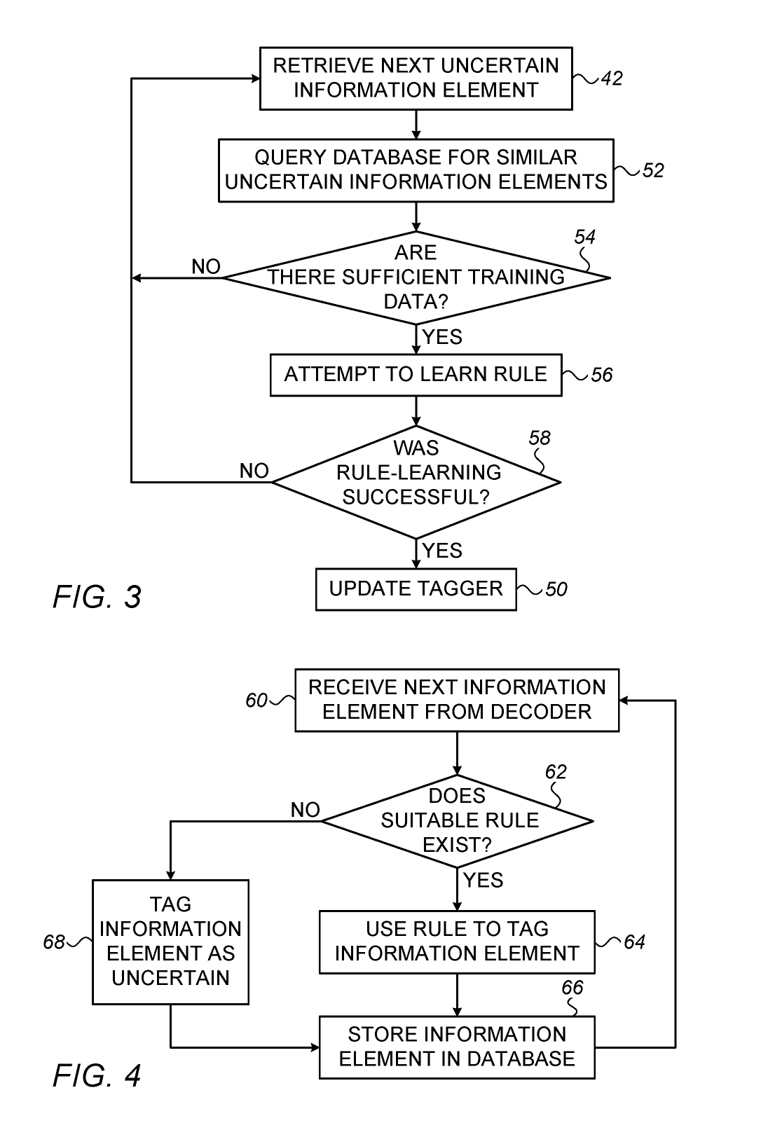

Reference is now made to FIG. 3, which shows a flow diagram for the operation of unsupervised learner 38, in accordance with some embodiments described herein.

First, at first retrieving step 42, the unsupervised learner retrieves, from the database, an uncertain information element. At a database-querying step 52, the unsupervised learner then queries the database for uncertain information elements that are similar to the retrieved uncertain information element. (As described above, “similar,” in this context, means that the uncertain information elements are of the same type, were exchanged with the same client, and are within a given time threshold of each other.) At a decision step 54, the unsupervised learner then decides if there are sufficient training data. If yes, at an attempted-rule-learning step 56, the unsupervised learner attempts to learn a rule, by attempting to identify a subset of the training data that are similar in value to each other. Otherwise, the unsupervised learner returns to first retrieving step 42, and retrieves an uncertain information element associated with a different client.

Following attempted-rule-learning step 56, the unsupervised learner, at a rule-learning-evaluation step 58, evaluates whether a rule was successfully learned, i.e., whether a sufficiently large subset of the training data are sufficiently close in value to each other. If yes, the unsupervised learner then updates the tagger, at updating step 50. Otherwise, the unsupervised learner returns to first retrieving step 42, and retrieves an uncertain information element associated with a different client.

In some embodiments, further to learning a rule, the supervised learner or unsupervised learner may retag, in the database, the uncertain information elements that were used to learn the rule. Typically, however, no retroactive tagging is performed; rather, the training data are left as is, and the learned rule is used only for the tagging of newly-received information elements.

### Tagging of Information Elements

Reference is now made to FIG. 4, which is a flow diagram for the operation of tagger 34, in accordance with some embodiments described herein.

At a receiving step 60, the tagger receives an information element from the decoder. At a rule-seeking step 62, the tagger attempts to find a rule that is suitable for tagging the information element. If a suitable rule exists, the tagger uses the rule to tag the information element with a deduced semantic role (and, typically, a level of certainty), at a tagging step 64. Otherwise, the tagger, at an alternate tagging step 68, tags the information element as uncertain. (It is noted that even an information element tagged in tagging step 64 may be treated as uncertain, if the level of certainty associated with the tagging is below a certain threshold, e.g., 10%.) Subsequently, at a storing step 66, the information element is stored in the database.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a network interface; and
one or more processors, configured to:
using training data that include information elements, automatically learn a rule that relates to a semantic role of at least a subset of the information elements,
subsequently, extract, from communication exchanged over a computer network and received via the network interface, an information element whose semantic role is uncertain, and
using the rule, deduce the semantic role of the extracted information element.

2. The system according to claim 1, wherein the processors are further configured to store the extracted information element, in a database, in a manner that indicates the deduced semantic role of the extracted information element.

3. The system according to claim 1, wherein the processors are configured to compute, using the rule, a level of certainty that the semantic role of the extracted information element is as deduced.

4. The system according to claim 3, wherein the processors are further configured to store the extracted information element, in a database, in association with the level of certainty.

5. The system according to claim 1, wherein the processors are configured to deduce the semantic role of the extracted information element by deducing that the extracted information element is a location of a particular device.

6. The system according to claim 1, wherein the information elements included in the training data include ground truth information elements whose respective semantic roles are certain, and wherein the processors are configured to use the training data by using the ground truth information elements.

7. The system according to claim 6, wherein the subset of the information elements includes uncertain training information elements whose respective semantic roles are uncertain, and wherein the processors are configured to automatically learn the rule by:
for each uncertain training information element of the uncertain training information elements:
selecting a corresponding one of the ground truth information elements that (i) is of the same type as the uncertain training information element, and (ii) was associated with a particular entity at a time that is within a particular threshold of a time at which the uncertain training information element was associated with the entity, and
ascertaining whether a value of the corresponding one of the ground truth information elements is sufficiently close to a value of the uncertain training information element; and
learning the rule, based on the ascertaining for all of the uncertain training information elements.

8. The system according to claim 6, wherein the information elements included in the training data were extracted from communication exchanged in accordance with a particular application protocol, and wherein the processors are configured to learn the rule by at least partly learning the particular application protocol.

9. The system according to claim 1, wherein the processors are configured to automatically learn the rule by ascertaining that respective values of the information elements in the subset are sufficiently close to each other.

10. A method, comprising:
using training data that include information elements, automatically learning a rule that relates to a semantic role of at least a subset of the information elements;
subsequently, extracting, from communication exchanged over a computer network, an information element whose semantic role is uncertain; and
using the rule, deducing the semantic role of the extracted information element.

11. The method according to claim 10, further comprising storing the extracted information element, in a database, in a manner that indicates the deduced semantic role of the extracted information element.

12. The method according to claim 10, further comprising, using the rule, computing a level of certainty that the semantic role of the extracted information element is as deduced.

13. The method according to claim 12, further comprising storing the extracted information element, in a database, in association with the level of certainty.

14. The method according to claim 10, wherein deducing the semantic role of the extracted information element comprises deducing that the extracted information element is a location of a particular device.

15. The method according to claim 10, wherein the information elements included in the training data include ground truth information elements whose respective semantic roles are certain, and wherein using the training data comprises using the ground truth information elements.

16. The method according to claim 15, wherein the subset of the information elements includes uncertain training information elements whose respective semantic roles are uncertain, and wherein automatically learning the rule comprises:
for each uncertain training information element of the uncertain training information elements:
selecting a corresponding one of the ground truth information elements that (i) is of the same type as the uncertain training information element, and (ii) was associated with a particular entity at a time that is within a particular threshold of a time at which the uncertain training information element was associated with the entity, and
ascertaining whether a value of the corresponding one of the ground truth information elements is sufficiently close to a value of the uncertain training information element; and
learning the rule, based on the ascertaining for all of the uncertain training information elements.

17. The method according to claim 15, wherein the information elements included in the training data were extracted from communication exchanged in accordance with a particular application protocol, and wherein learning the rule comprises at least partly learning the particular application protocol.

18. The method according to claim 10, wherein automatically learning the rule comprises automatically learning the rule by ascertaining that respective values of the information elements in the subset are sufficiently close to each other.

19. A computer software product comprising a tangible non-transitory computer-readable medium in which program instructions are stored, which instructions, when read by one or more processors, cause the processors to:
using training data that include information elements, automatically learn a rule that relates to a semantic role of at least a subset of the information elements,
subsequently, extract, from communication exchanged over a computer network, an information element whose semantic role is uncertain, and
using the rule, deduce the semantic role of the extracted information element.

20. The computer software product according to claim 19, wherein the instructions further cause the processors to store the extracted information element, in a database, in a manner that indicates the deduced semantic role of the extracted information element.
